(19) United States
(12) Patent Application Publication
(10) Pub. No.: US 2014/0362309 A1
(43) Pub. Date: Dec. 11, 2014

(54) INPUT DEVICE, DISPLAY DEVICE, AND ELECTRONIC EQUIPMENT

(71) Applicant: KYOCERA Corporation, Kyoto-shi, Kyoto (JP)

(72) Inventors: Kouji Tsurusaki, Kirishima-shi (JP); Yoshio Miyazaki, Kirishima-shi (JP); Takashi Minami, Minamikusatsu-shi (JP)

(21) Appl. No.: 14/374,368

(22) PCT Filed: Dec. 28, 2012
(86) PCT No.: PCT/JP2012/084045

§ 371 Date: Jul. 24, 2014

(30) Foreign Application Priority Data
Jan. 25, 2012 (JP) 2012-013106

(51) Int. Cl. G06F 1/16

(52) U.S. Cl. CPC G06F 1/1656; G06F 1/1643; G06F 1/1692
USPC 349/12

(57) ABSTRACT

[Object] To provide an input device, a display device, and electronic equipment which can reduce a possibility of corrosion of detection electrodes while reducing a possibility of damage to the detection electrodes due to contact with the outside.

[Solution] An input device X1 includes: a base 2; a first detection electrode pattern 3 on a second main surface 2b of the base 2; an inorganic layer 11 on the second main surface 2b of the base 2 so as to cover the detection electrode pattern 3 in plan view; and a protection member 12 on the inorganic layer 11, in which the protection member 12 includes an organic layer 12a which contacts with the inorganic layer 11 and has adhesiveness, and a protection layer 12b on the organic layer 12a.

### TECHNICAL FIELD

The present invention relates to an input device, a display device, and electronic equipment.

### BACKGROUND ART

In the related art, a capacitive touch panel which detects an input position on the basis of changes in capacitance between a finger and detection electrodes has been known as an input device. In such input device, detection electrodes are provided on a base. In addition, a protection member including an adhesion layer and a protection layer formed of an organic material is bonded onto the base, in order to reduce a possibility of damage to the detection electrode due to contact with the outside (for example, see PTL 1).

### CITATION LIST

### Patent Literature

PTL 1: Japanese Unexamined Patent Application Publication No. 2011-96234

### SUMMARY OF INVENTION

### Technical Problem

However, in the input device described above, moisture may easily penetrate through the adhesion layer or the protection layer of the protection member, and therefore the detection electrode may be corroded.

The invention is made in consideration of these circumstances and an object thereof is to provide an input device, a display device, and electronic equipment which can reduce a possibility of corrosion of detection electrodes while reducing a possibility of damage to the detection electrodes due to contact with the outside.

### Solution to Problem

An input device according to an embodiment of the present invention includes: a base; a detection electrode pattern on a main surface of the base; an inorganic layer on the main surface of the base so as to cover the detection electrode pattern in plan view; and a protection member on the inorganic layer, in which the protection member includes an organic layer which contacts with the inorganic layer and has adhesiveness, and a protection layer on the organic layer.

A display device according to an embodiment of the present invention includes: the input device according to the present invention; a display panel which is disposed to oppose the input device; and a housing which accommodates the display panel.

An electronic equipment according to an embodiment of the present invention includes the display device according to the present invention.

### Advantageous Effects of Invention

The input device, the display device, and the electronic equipment of the present invention can realize effects of protecting the detection electrode while reducing a possibility of corrosion of the detection electrode.

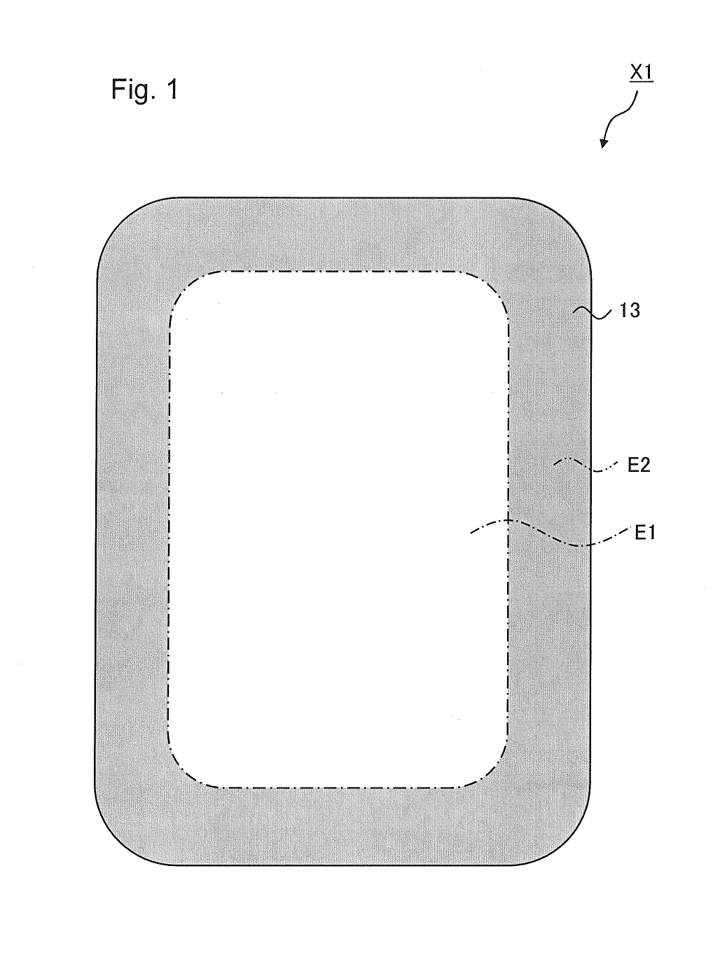

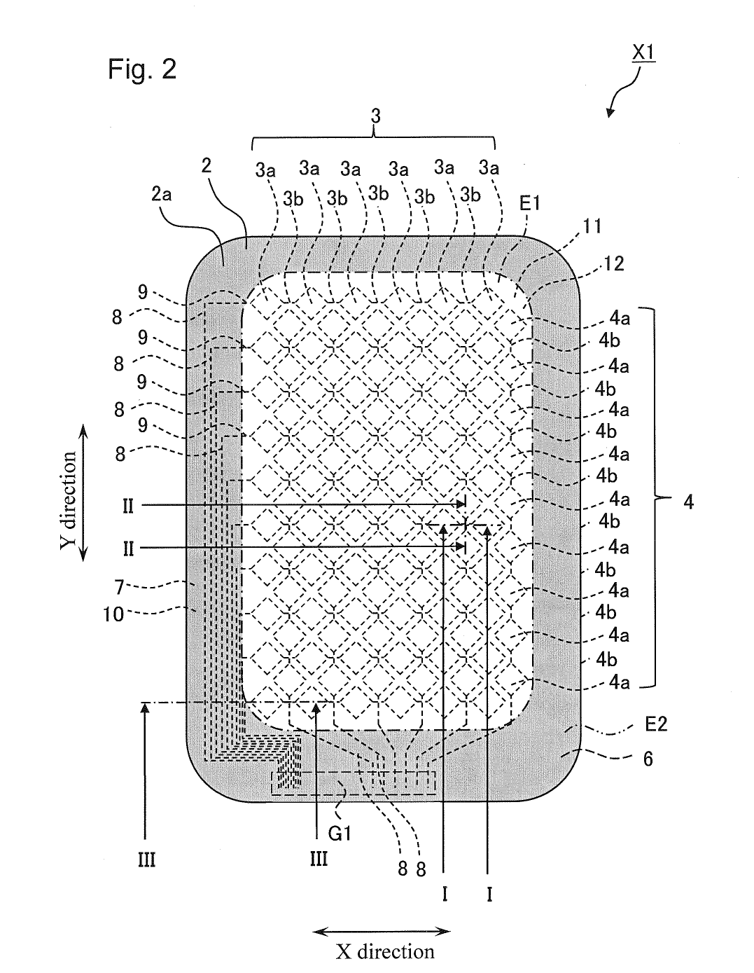

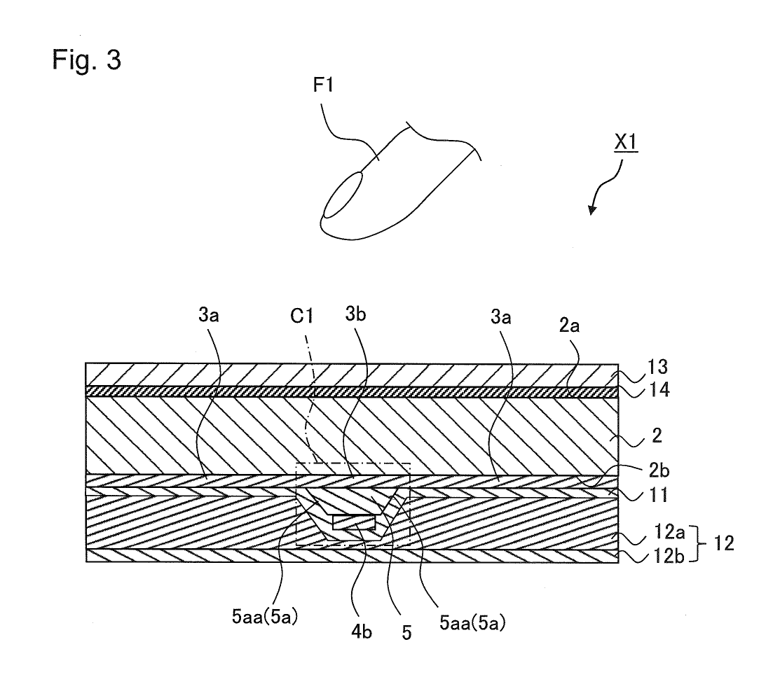

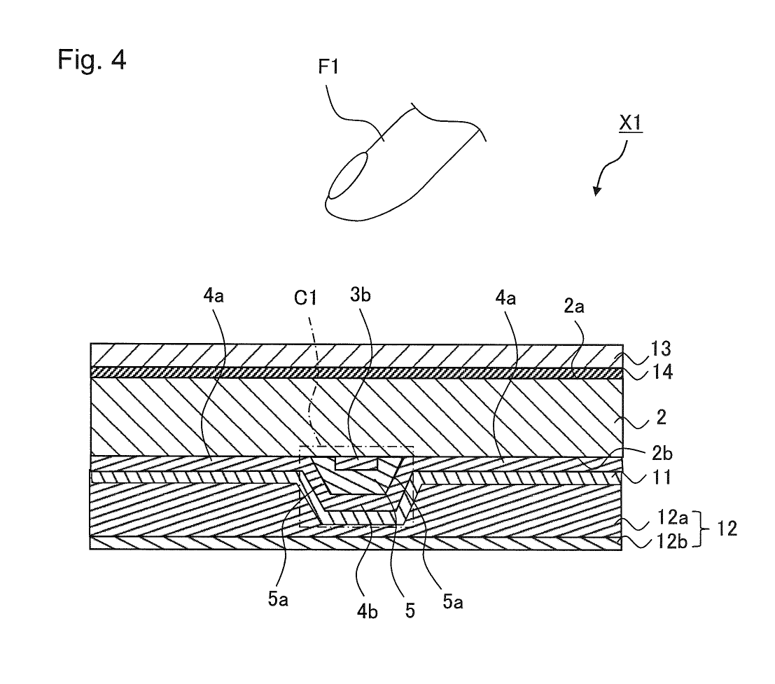

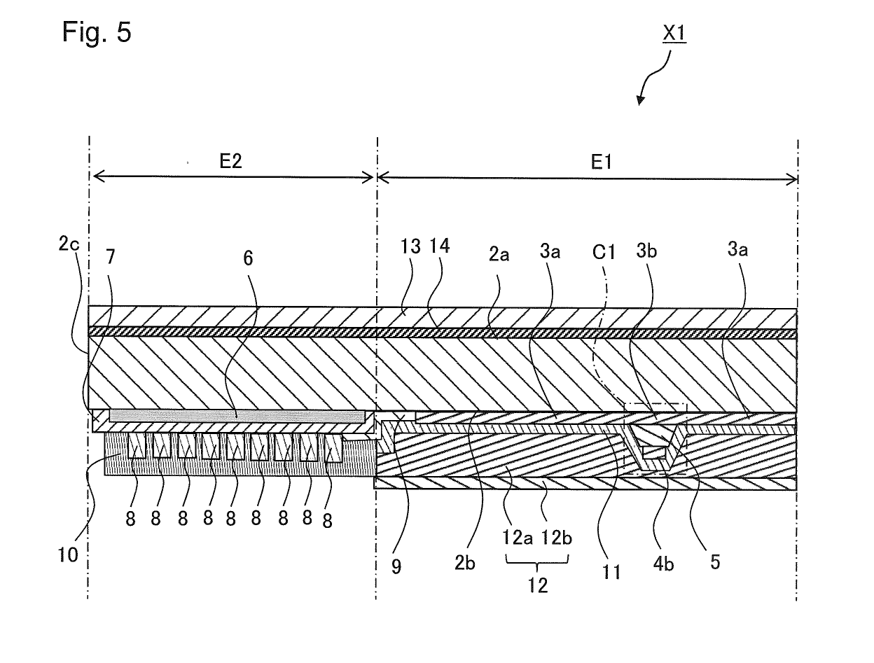

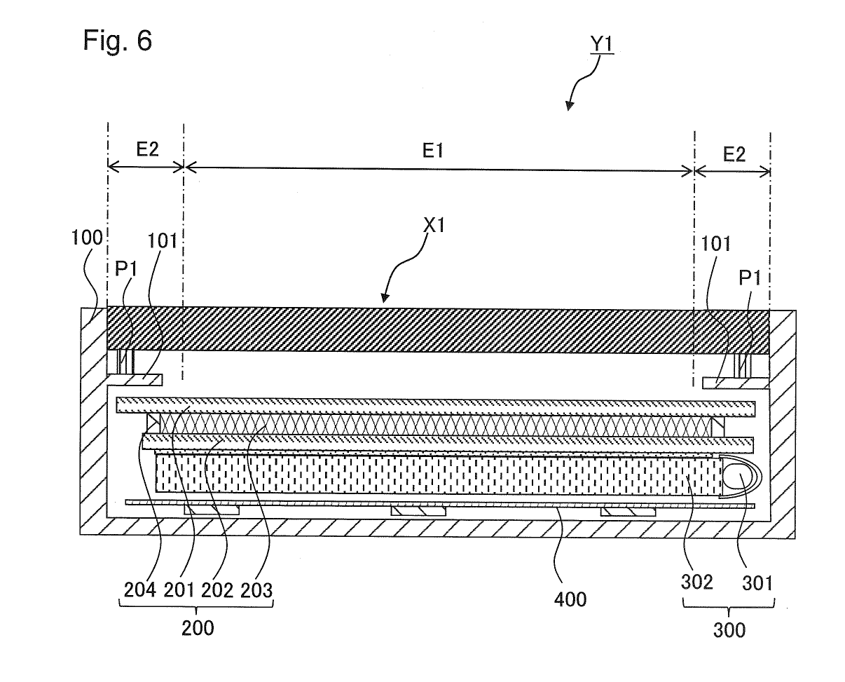

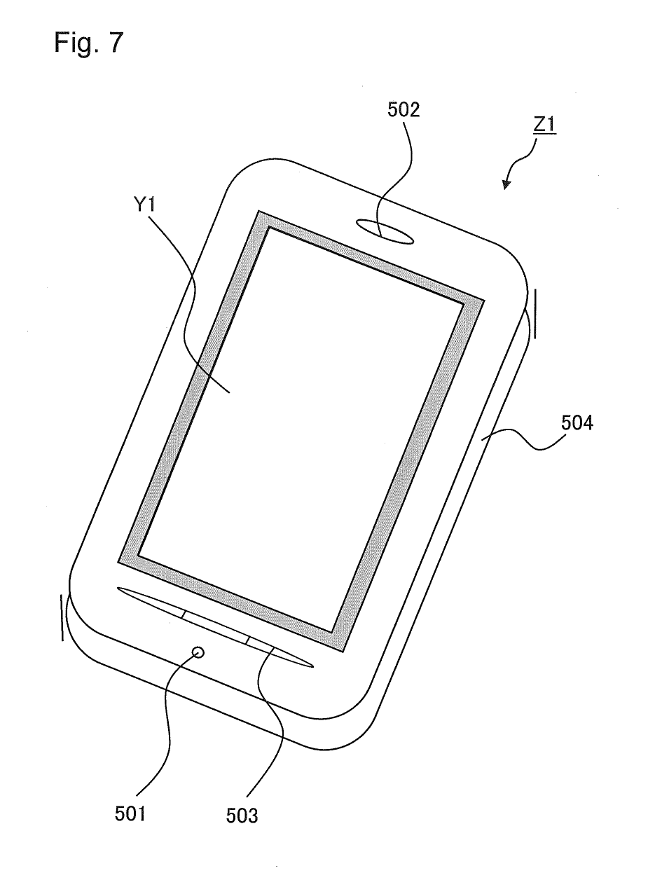

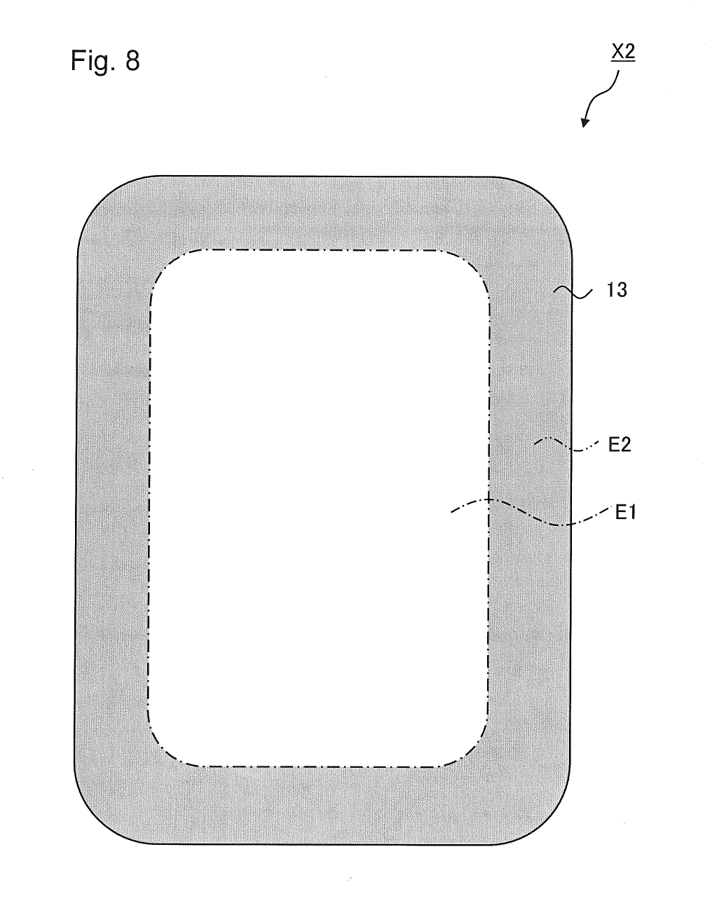

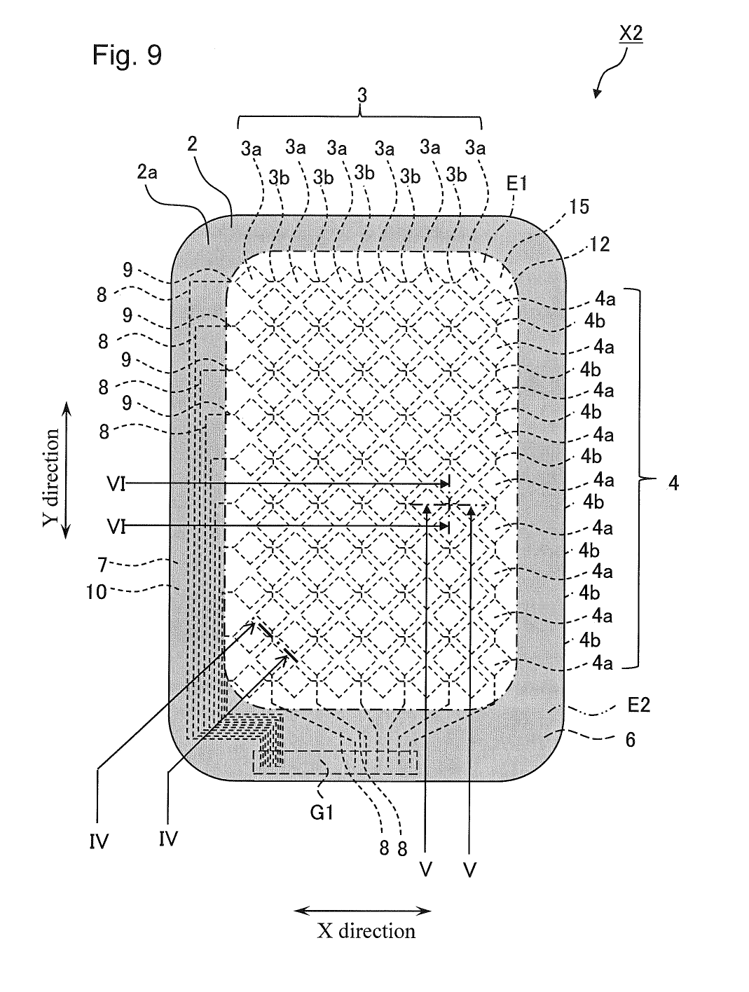

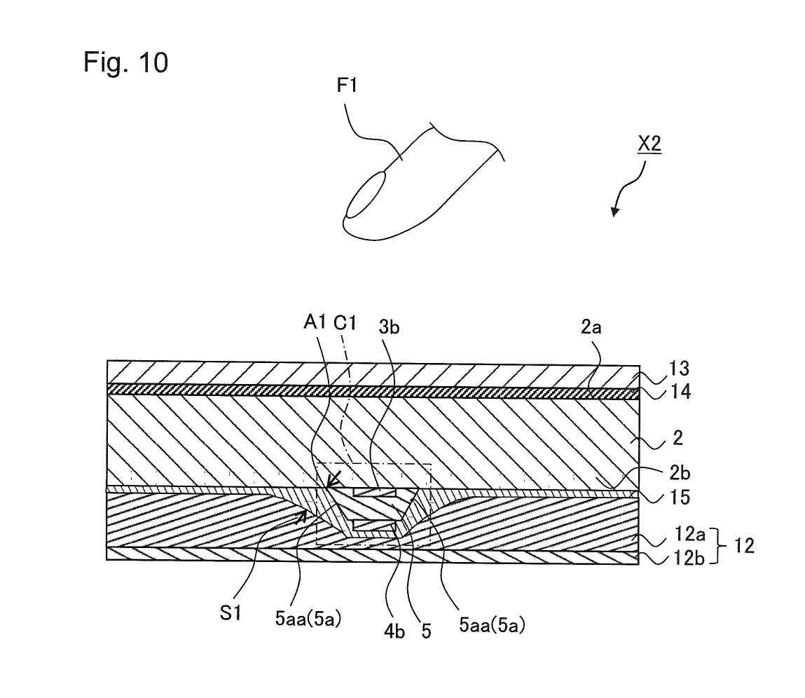

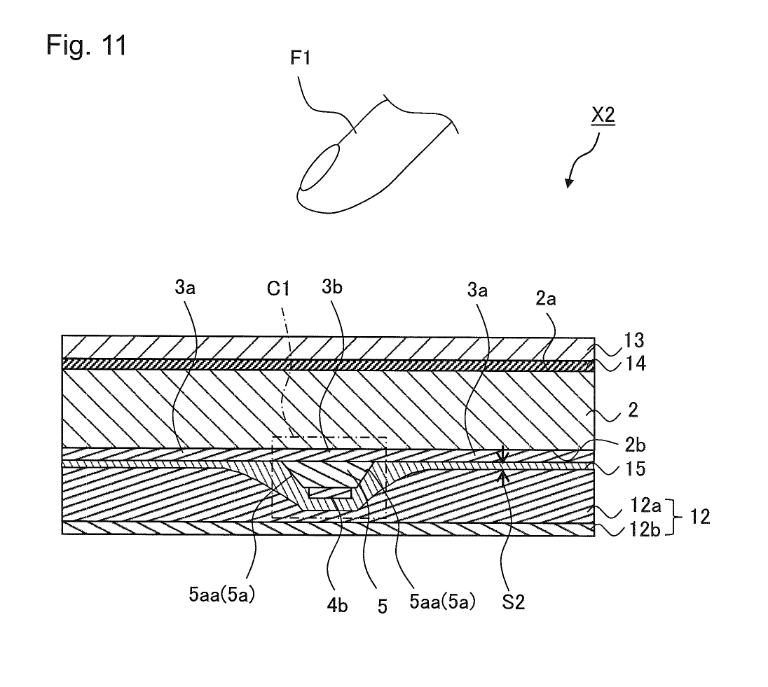

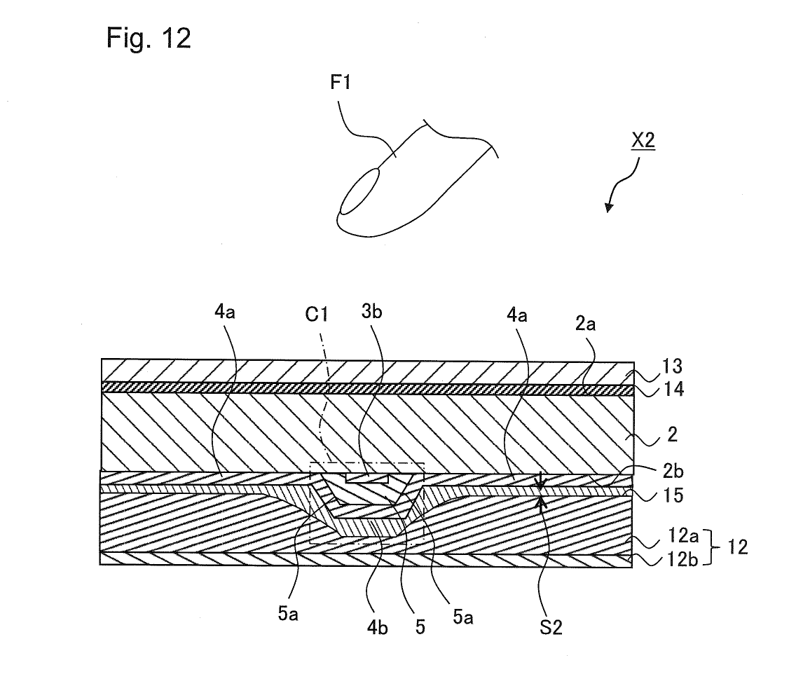

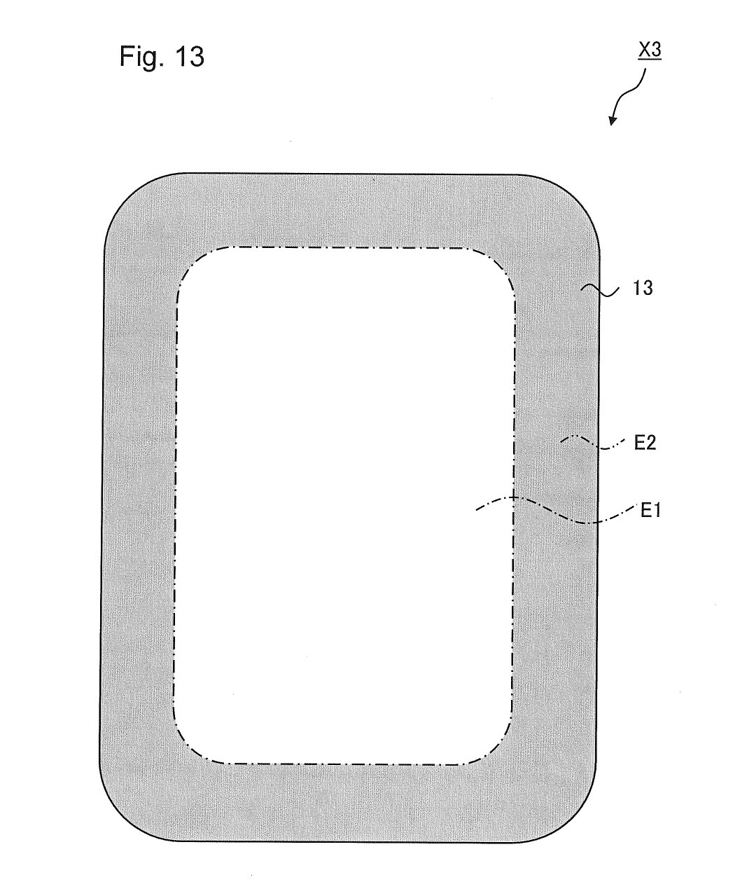

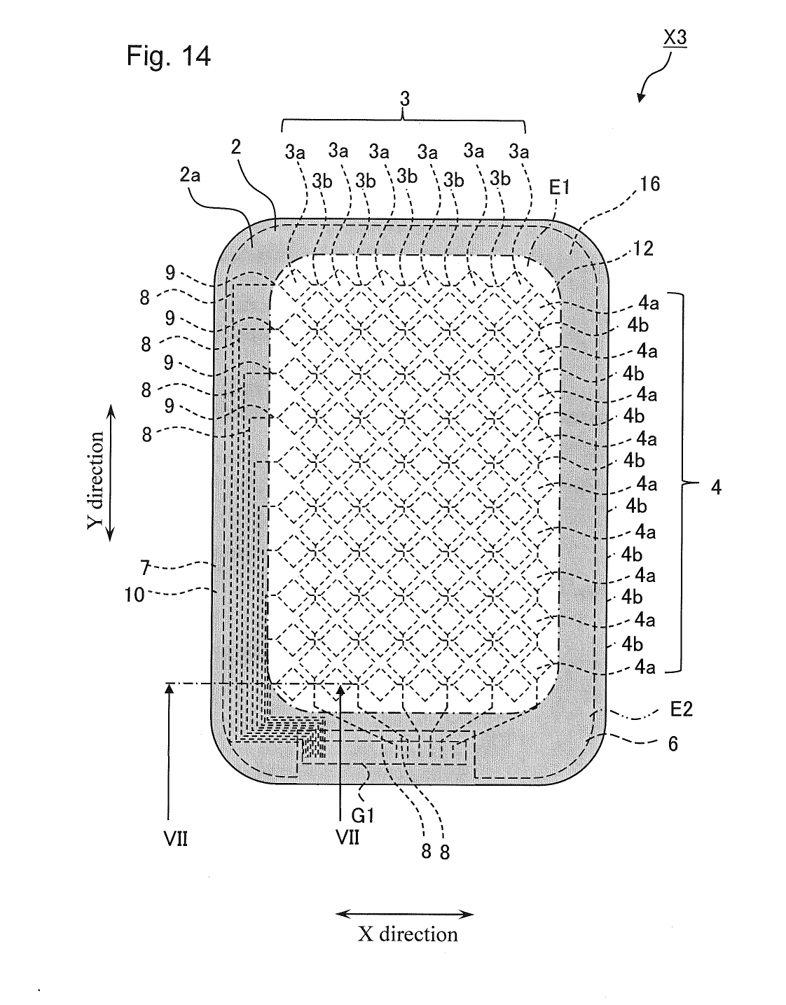

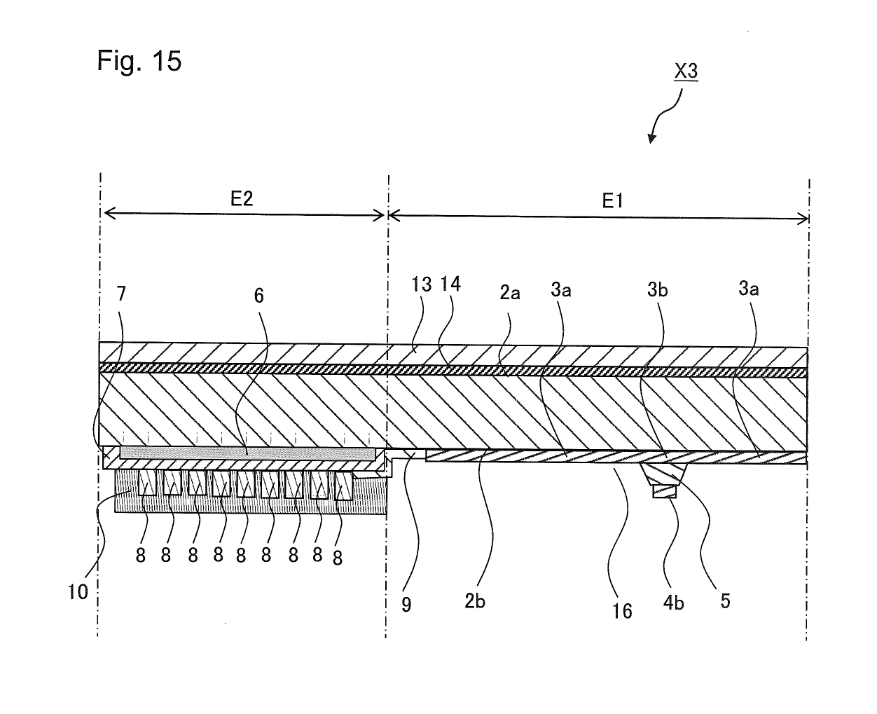

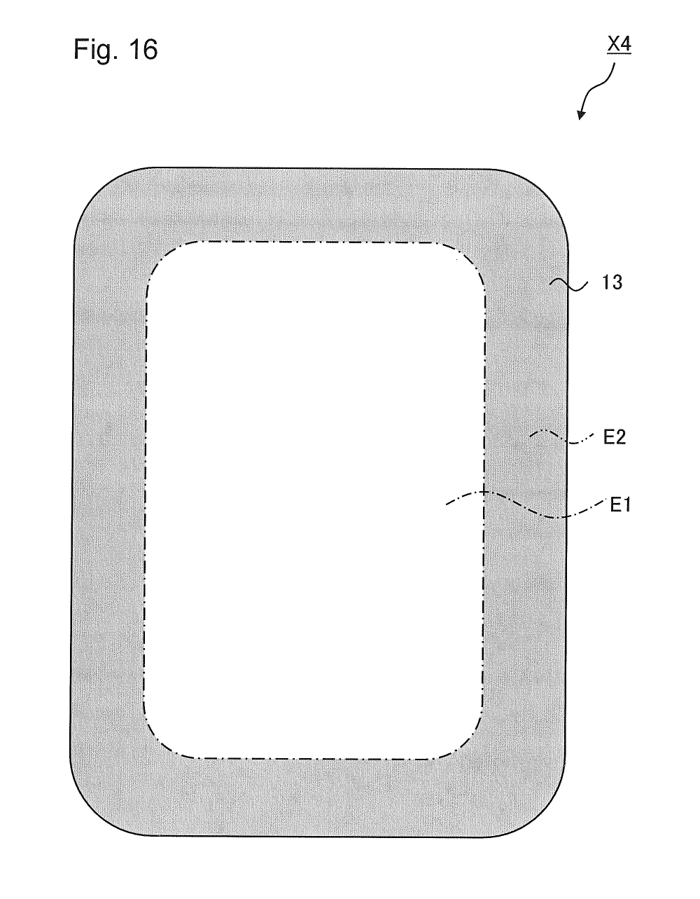

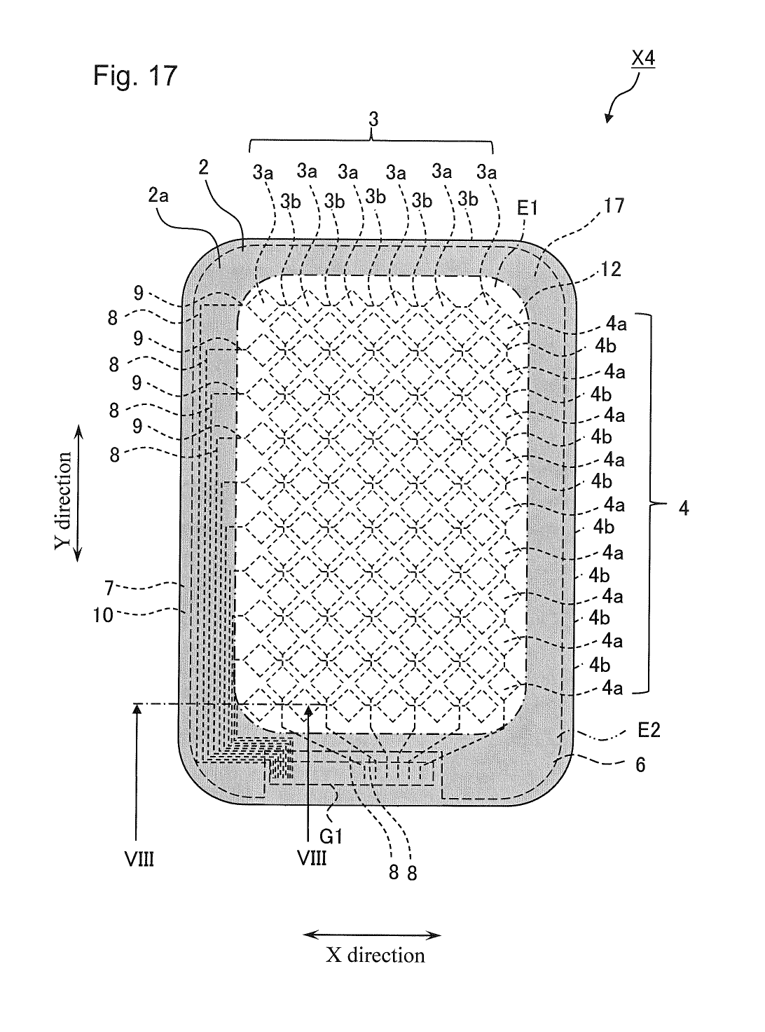

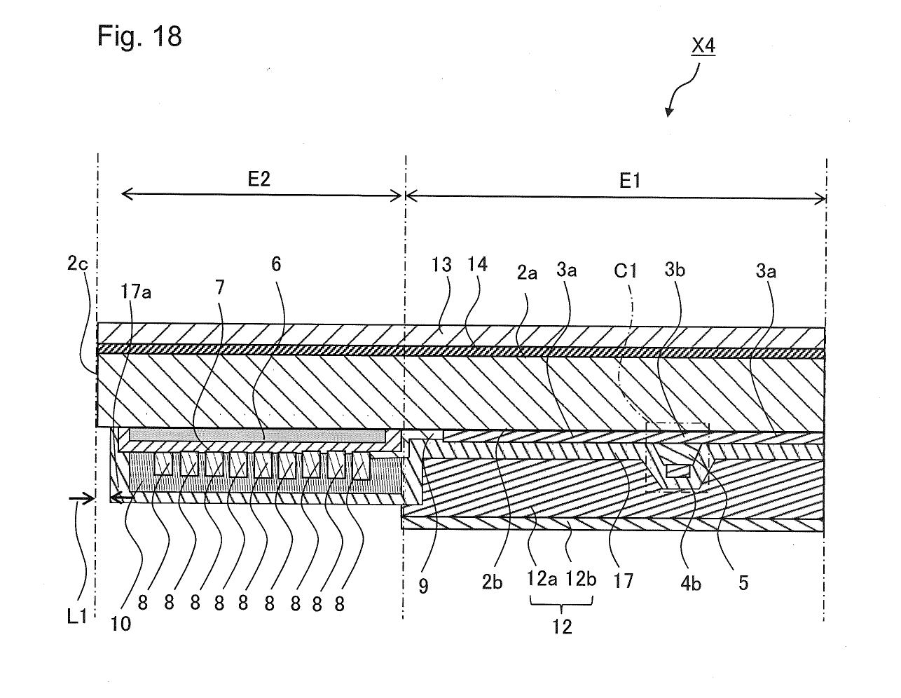

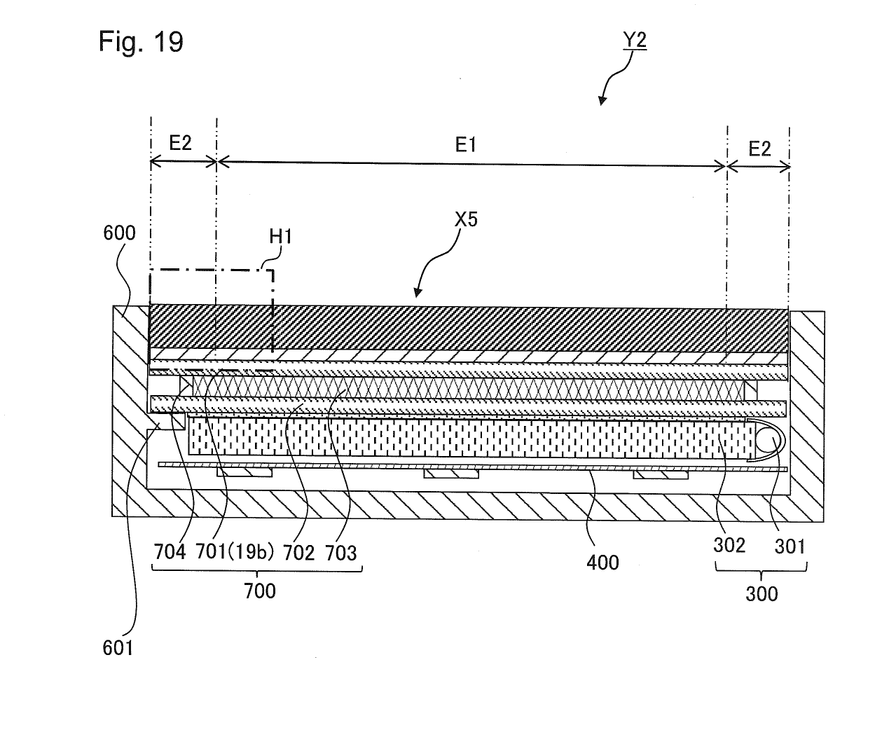

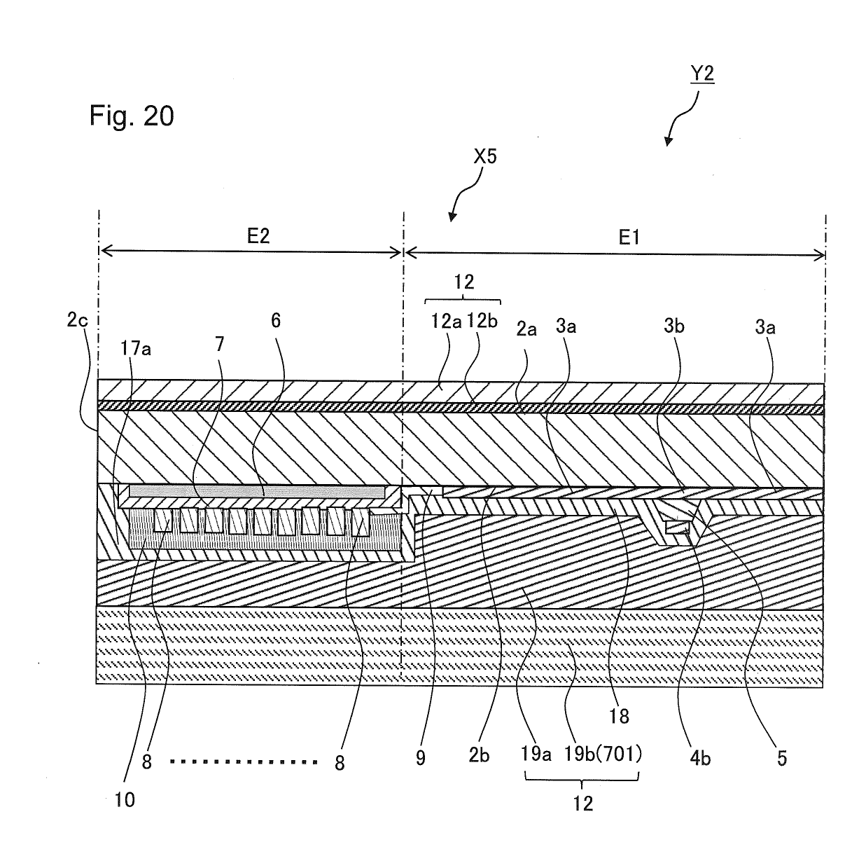

### BRIEF DESCRIPTION OF DRAWINGS

[FIG. 1] FIG. 1 is a plan view illustrating a schematic configuration of an input device according to the embodiment.

[FIG. 2] FIG. 2 is a plan view illustrating a schematic configuration of the input device according to the embodiment and is a view seen through a base.

[FIG. 3] FIG. 3 is a cross-sectional view taken along line I-I shown in FIG. 2.

[FIG. 4] FIG. 4 is a cross-sectional view taken along line II-II shown in FIG. 2.

[FIG. 5] FIG. 5 is a cross-sectional view taken along line III-III shown in FIG. 2.

[FIG. 6] FIG. 6 is a cross-sectional view illustrating a schematic configuration of a display device according to the embodiment.

[FIG. 7] FIG. 7 is a perspective view illustrating a schematic configuration of a mobile terminal according to the embodiment.

[FIG. 8] FIG. 8 is a plan view illustrating a schematic configuration of an input device according to Modification Example 1.

[FIG. 9] FIG. 9 is a plan view illustrating a schematic configuration of an input device according to Modification Example 1 and is a view seen through a base.

[FIG. 10] FIG. 10 is a cross-sectional view taken along line IV-IV shown in FIG. 9.

[FIG. 11] FIG. 11 is a cross-sectional view taken along line V-V shown in FIG. 9.

[FIG. 12] FIG. 12 is a cross-sectional view taken along line VI-VI shown in FIG. 9.

[FIG. 13] FIG. 13 is a plan view illustrating a schematic configuration of an input device according to Modification Example 2.

[FIG. 14] FIG. 14 is a plan view illustrating a schematic configuration of an input device according to Modification Example 2 and is a view seen through a base.

[FIG. 15] FIG. 15 is a cross-sectional view taken along line VII-VII shown in FIG. 13.

[FIG. 16] FIG. 16 is a plan view illustrating a schematic configuration of an input device according to Modification Example 3.

[FIG. 17] FIG. 17 is a plan view illustrating a schematic configuration of an input device according to Modification Example 3 and is a view seen through a base.

[FIG. 18] FIG. 18 is a cross-sectional view taken along line VIII-VIII shown in FIG. 16.

[FIG. 19] FIG. 19 is a cross-sectional view illustrating a schematic configuration of a display device according to Modification Example 4.

[FIG. 20] FIG. 20 is an enlarged view of an area H1 surrounded with a dashed/dotted line shown in FIG. 19.

### DESCRIPTION OF EMBODIMENTS

Hereinafter, embodiments of the present invention will be described with reference to the drawings.

Herein, for convenience of description, each drawing referred hereinafter simply illustrates main members necessary for describing the present invention, among constituent elements of an embodiment of the present invention. Accordingly, an input device, a display device, and electronic equipment according to the present invention may include any other constituent elements not shown in each drawing of the present specification.

As illustrated in FIG. 1 and FIG. 2, an input device X1 according to the embodiment is a projected capacitive touch panel, and includes an input area E1 and a non-input area E2. The input area E1 is an area where a user can perform an input operation. The non-input area E2 is an area where a user cannot perform the input operation. The non-input area E2 according to the embodiment is positioned outside of the input area E1 so as to surround the input area E1, but the position is not limited thereto. The non-input area E2 may be positioned in the input area E1, for example. In addition, the input device X1 is not limited to the projected touch panel, and may be a surface capacitive touch panel, for example.

In the embodiment, the input device X1 is a cover glass integrated type capacitive touch panel, but the input device X1 is not limited thereto. The input device X1 may be a laminated or on-cell type capacitive touch panel, for example.

As illustrated in FIGS. 1 to 5, the input device X1 includes a base 2.

The base 2 supports a first detection electrode pattern 3, a second detection electrode pattern 4, an insulator 5, a light shielding layer 6, a first insulating layer 7, detection wires 8, a connection wire 9, a second insulating layer 10, an inorganic layer 11, a protection member 12, a protection sheet 13, and an adhesion layer 14 which will be described later. In FIG. 2, for convenience of description, the insulator 5, the protection sheet 13, and the adhesion layer 14 are omitted.

The base 2 includes a first main surface 2a, a second main surface 2b, and end surfaces 2c. The first main surface 2a is the surface positioned closer to a user as compared to the second main surface 2b. The second main surface 2b is positioned opposite the first main surface 2a. The end surface 2c is positioned between the first main surface 2a and the second main surface 2b. In the embodiment, the base 2 has an approximately rectangular shape in plan view. Accordingly, four end surfaces 2c are provided to correspond to four sides of the base 2 in plan view. The base 2 may have an approximately polygonal shape or an approximately circular shape in plan view. The base 2 has an insulating property and translucency with respect to light which is incident in a direction intersecting the first main surface 2a and the second main surface 2b. The “translucency” in the present specification means a property of transmitting part or all of visible light.

In the embodiment, a material constituting the base 2 is glass. Particularly, glass which is subjected to chemical strengthening by ion exchange is preferable, in order to improve strength. Herein, when the base 2 is the glass subjected to chemical strengthening, the chemically strengthened layer is also included in the base 2. As the material of the base 2, plastic may be used instead of glass.

The first detection electrode pattern 3 generates capacitance between the first detection electrode pattern 3 and a finger F1 of a user that has approached the first main surface 2a of the base 2 corresponding to the input area E1, and detect an input position in a long side direction of the base 2 (Y direction in FIG. 2) in plan view. A plurality of first detection patterns 3 are provided on the second main surface 2b of the base 2 corresponding to the input area E1, in a line in the Y direction. In addition, the first detection electrode pattern 3 includes first detection electrodes 3a and first interelectrode wires 3b.

The first detection electrodes 3a generate capacitance between the first detection electrodes and the finger F1 of a user. The plurality of first detection electrodes 3a are provided in a line in a short side direction of the base 2 (X direction in FIG. 2) in plan view. The first interelectrode wires 3b electrically connect the first detection electrodes 3a to each other. The first interelectrode wires 3b are provided between the first detection electrodes 3a adjacent to each other.

The second detection electrode pattern 4 generates capacitance between the second detection electrode pattern 4 and the finger F1 of a user that has approached the first main surface 2a of the base 2 corresponding to the input area E1, and detects an input position in an X direction. A plurality of second detection electrode patterns 4 are provided on the second main surface 2b of the base 2 corresponding to the input area E1 in a line in the X direction. In addition, the second detection electrode pattern 4 includes second detection electrodes 4a and second interelectrode wires 4b.

The second detection electrodes 4a generate capacitance between the second detection electrodes 4a and the finger F1 of a user. A plurality of second detection electrodes 4a are provided in a line in the Y direction. The second interelectrode wires 4b electrically connect the second detection electrodes 4a to each other. The second interelectrode wire 4b is provided between the second detection electrodes 4a adjacent to each other, and on the insulator 5 so as to be electrically insulated from the first interelectrode wire 3b.

Herein, the insulator 5 is provided on the second main surface 2b of the base 2 so as to cover the first interelectrode wire 3b, in an intersected portion C1 in which the first detection electrode pattern 3 and the second detection electrode pattern 4 intersect with each other. As illustrated in FIG. 3 and FIG. 4, the insulator 5 has a width which becomes smaller towards the protection member 12. In addition, the insulator 5 includes an end surface 5a. The end surface 5a is preferably a curved surface. When the end surface 5a is a curved surface, it is possible to reduce a possibility of peeling of the second interelectrode wire 4b positioned on the insulator 5. As a material constituting the insulator 5, a resin formed of an organic material is used. As the resin formed of an organic material, an acryl resin, an epoxy resin, or a silicone resin is used, for example.

The first detection electrode 3a and the second detection electrode 4a according to the embodiment have an approximately diamond shape in plan view, but they are not limited thereto and may have a polygonal shape or a circular shape. When the first detection electrode 3a and the second detection electrode 4a have an approximately diamond shape in plan view, it is possible to narrow a gap between the first detection electrode 3a and the second detection electrode 4a. As a result, it is possible to relatively increase areas of the first detection electrode 3a and the second detection electrode 4a on the second main surface 2b of the base 2. Accordingly, it is possible to increase capacitance generated between the first detection electrode 3a and the second detection electrode 4a, and the finger F1, and detection sensitivity of the input device X1 is improved.

As a material constituting the first detection electrode pattern 3 and the second detection electrode pattern 4 described above, a conductive member having translucency is used. As the conductive member having translucency, indium tin oxide (ITO), indium zinc oxide (IZO), Al-doped zinc oxide (ATO), tin oxide, zinc oxide, or a conductive polymer is used, for example.

As a method of forming the first detection electrode pattern 3 and the second detection electrode pattern 4, a film of the material described above is formed on the second main surface 2b of the base 2 by a sputtering method, a vapor-deposition method, or a chemical vapor deposition (CVD) method. The surface of this film is coated with a photosensitive resin, and the film is patterned through exposing, developing, and etching, and accordingly the first detection electrode pattern 3 and the second detection electrode pattern 4 are formed.

The light shielding layer 6 shields light incident in a direction intersecting with the first main surface 2a and the second main surface 2b of the base 2. To “shield light” in the present specification means to shield part or all of visible light by reflection or absorption. The light shielding layer 6 is positioned on the second main surface 2b of the base 2, and is provided on the entire area on the second main surface 2b of the base 2 corresponding to the non-input area E2. Accordingly, the light shielding layer 6 can shield light on the entire area of the base 2 corresponding to the non-input area E2. The light shielding layer 6 may be provided on a part of the area corresponding to the non-input area E2. In addition, the light shielding layer 6 may be provided on the first main surface 2a of the base 2 corresponding to the non-input area E2.

As a material constituting the light shielding layer 6, a material including a coloring material in a resin material is used. As the resin material, an acrylic resin, an epoxy resin, or a silicone resin is used, for example. As the coloring material, carbon, titanium, or chrome is used, for example. The color of the light shielding layer 6 is not limited to black, and the light shielding layer 6 may be colored other than black. As a method of forming the light shielding layer 6, a screen printing method, a sputtering method, a CVD method, or a vapor-deposition method is used, for example.

The first insulting layer 7 protects the light shielding layer 6 from corrosion due to moisture absorption. The first insulating layer 7 is provided on the second main surface 2b of the base 2 corresponding to the non-input area E2. In detail, the first insulating layer 7 is positioned on the light shielding layer 6 and coats the light shielding layer 6. As a material constituting the first insulating layer 7, an acrylic resin or an epoxy resin is used, for example. As a method of forming the first insulating layer 7, a transfer printing method, a spin coating method, or a slit coating method is used, for example.

The detection wires 8 detect a change in capacitance generated between the first detection electrode pattern 3 and the second detection electrode pattern 4, and the finger F1. The detection wires 8 are provided on the second main surface 2b of the base 2 corresponding to the non-input area E2. In detail, the detection wires 8 are positioned on the first insulating layer 7. Accordingly, even if the coloring material included in the first light shielding layer 6 has conductivity, it is possible to reduce a possibility of electrical connection between the light shielding layer 6 and the detection wires 8. In addition, the first insulating layer 7 may not be provided, and the detection wires 8 may be directly provided on the light shielding layer 6. An end of each detection wire 8 is positioned in an external conductive area G1 on the second main surface 2b of the base 2. The other end of each detection wire 8 is connected to the connection wire 9.

The detection wire 8 is formed of a metal thin film, in order to obtain hardness and high shape stability. As a material constituting the metal thin film, an aluminum film, an aluminum alloy film, a laminated film of a chrome film and an aluminum film, a laminated film of a chrome film and an aluminum alloy film, a silver film, a silver alloy film, or a gold alloy film is used, for example. As a method of forming the metal thin film, a sputtering method, a CVD method, or a vapor-deposition method is used, for example.

The connection wire 9 electrically connects the first detection electrode pattern 3 and the detection wires 8 to each other, and electrically connects the second detection electrode pattern 4 and the detection wires 8 to each other. The connection wire 9 is positioned on the second main surface 2b of the base 2. In detail, as illustrated in FIG. 5, the connection wire 9 is provided over the input area E1 and the non-input area E2. The connection wire 9 connects the first detection electrodes 3a positioned on one end of the first detection electrode pattern 3, and the detection wire 8 to each other. In addition, the connection wire 9 connects the second detection electrodes 4a positioned on one end of the second detection electrode pattern 4, and the detection wire 8 to each other. As the material and the method of forming the connection wire 9, the same material and the forming method as those of the first detection electrode pattern 3 and the second detection electrode pattern 4 are used.

The second insulating layer 10 protects the detection wires 8 from corrosion due to moisture absorption. The second insulating layer 10 is provided on the second main surface 2b of the base 2 corresponding to the non-input area E2. In detail, the second insulating layer 10 is positioned on the detection wires 8, and coats the detection wires 8. The second insulating layer 10 is not provided on the external conductive area G1. As the material and the forming method of the second insulating layer 10, the same material and the forming method as those of the first insulating layer 7 are used.

The inorganic layer 11 protects the first detection electrode pattern 3 and the second detection electrode pattern 4 from corrosion due to moisture absorption. The inorganic layer 11 is provided on the second main surface 2b of the base 2 corresponding to the input area E1. The inorganic layer 11 coats the first detection electrode pattern 3 and the second detection electrode pattern 4. The inorganic layer 11 coats the entirety of the first detection electrode pattern 3 and the second detection electrode pattern 4 in plan view, but not limited thereto, and the inorganic layer may coat a part of the first detection electrode pattern 3 and the second detection electrode pattern 4. In a case where the inorganic layer 11 coats a part of the first detection electrode pattern 3 and the second detection electrode pattern 4, the remaining part of the first detection electrode pattern 3 and the second detection electrode pattern 4 is preferably covered by the protection member 12 which will be described later, for example.

As the material constituting the inorganic layer 11, an inorganic material having translucency is used. As the inorganic material having translucency, silicon dioxide or silicon nitride is used, for example. As a method of forming the inorganic layer 11, a sputtering method, an ion plating method, a screen printing method, or an ink jet printing method is used, for example.

As described above, in the input device X1, the inorganic layer 11 is provided on the second main surface 2b of the base 2 so as to cover the first detection electrode pattern 3 and the second detection electrode pattern 4 in plan view. Herein, the inorganic material which is the material constituting the inorganic layer 11 has a property of not easily passing moisture, compared to an organic material. Accordingly, in the input device X1, it is possible to reduce a possibility of corrosion of the first detection electrode pattern 3 and the second detection electrode pattern 4 due to absorption of moisture.

The inorganic layer 11 is preferably formed to have a relatively small thickness. In detail, the inorganic layer 11 is preferably formed with a thickness of 0.02 μm to 0.2 μm, for example. If the thickness of the inorganic layer 11 is smaller than 0.02 μm, it is difficult to efficiently protect the first detection electrode pattern 3 and the second detection electrode pattern 4 from corrosion due to absorption of moisture. In addition, if the thickness of the inorganic layer 11 is larger than 0.02 μm, the base 2 may be bent due to a difference between coefficients of thermal expansion of the inorganic layer 11 and the base 2. Therefore, the inorganic layer 11 is preferably formed with the thickness of 0.02 μm to 0.2 μm.

However, if the thickness of the inorganic layer 11 is relatively small, when mounting the input device X1 on a display device Y1, a first housing 100 and the inorganic layer 11 may contact with each other, and the first detection electrode pattern 3 and the second detection electrode pattern 4 positioned under the inorganic layer 11 may be damaged. In addition, if the thickness of the inorganic layer 11 is relatively small, a difference between a distance from the second main surface 2b of the base 2 in an area where the insulator 5 is positioned in plan view to the surface of the inorganic layer 11 and a distance from the second main surface 2b of the base 2 in an area where the insulator 5 is not positioned in plan view to the surface of the inorganic layer 11 relatively increases. Accordingly, the area where the insulator 5 is positioned in plan view and the area where the insulator 5 is not positioned in plan view have different light transmittance, reflectance, or the like. Thus, the intersected portion C1 may be visually recognized by a user. Therefore, the input device X1 includes the protection member 12.

The protection member 12 includes an organic layer 12a and a protection layer 12b. As a material constituting the organic layer 12a, an acrylic adhesive, a silicone adhesive, a rubber adhesive, or a urethane adhesive is used, for example. In addition, as a material constituting the protection layer 12b, glass or plastic is used.

The organic layer 12a has adhesiveness and contacts with the inorganic layer 11. The protection layer 12b is provided on the organic layer 12a. Herein, the protection member 12 is provided on the second main surface 2b of the base 2 corresponding to the input area E1. In detail, the protection member 12 is positioned so as to cover the first detection electrode pattern 3 and the second detection electrode pattern 4 in plan view. Accordingly, when mounting the input device X1 on the display device Y1, it is possible to reduce a possibility of damage to the first detection electrode pattern 3 and the second detection electrode pattern 4 due to contact of the first housing 100 with the inorganic layer 11. In addition, since the inorganic layer 11 and the protection member 12 are positioned on the first detection electrode pattern 3 and the second detection electrode pattern 4, it is possible to reduce a possibility of relative increase in difference between a distance from the second main surface 2b of the base 2 in an area where the insulator 5 is positioned in plan view to the surface of the protection member 12 and a distance from the second main surface 2b of the base 2 in an area where the insulator 5 is not positioned in plan view to the surface of the protection member 12. Therefore, it is possible to reduce a possibility of visual recognition of the intersected portion C1 by a user.

As described above, in the input device X1, the inorganic layer 11 is provided on the second main surface 2b of the base 2 so as to cover the first detection electrode pattern 3 and the second detection electrode pattern 4 in plan view. In addition, the protection member 12 includes the organic layer 12a and the protection layer 12b. The organic layer 12a has adhesiveness and contacts with the inorganic layer 11. The protection layer 12b is provided on the organic layer 12a. Therefore, it is possible to reduce a possibility of damage to the first detection electrode pattern 3 and the second detection electrode pattern 4 due to contact with the outside, and to reduce a possibility of corrosion of the first detection electrode pattern 3 and the second detection electrode pattern 4.

According to the input device X1, effects of reducing a possibility of a part of the protection member 12 remaining, and easily replacing the protection member 12 are obtained.

In detail, in an input device of the related art, a first detection electrode pattern and a second detection electrode pattern are provided on a second main surface of a base. Accordingly, concavities and convexities are generated between a portion where the first detection electrode pattern and the second detection electrode pattern are provided and a portion where the first detection electrode pattern and the second detection electrode pattern are not provided. Thus, concavities and convexities are also generated on an inorganic layer provided on the portions thereof. Therefore, when the protection member is attempted to be bonded onto the inorganic layer, air bubbles may enter between the inorganic layer and the protection member. If the air bubbles enter between the inorganic layer and the protection member, variation may occur in magnitude of parasitic capacitance between the first detection electrode pattern and the second detection electrode pattern. Thus, variation may occur in detection sensitivity of the input device.

In addition, for example, when mounting the input device on the display device, the protection member corresponding to the input area may be damaged in manufacturing the display device. If the protection member corresponding to the input area is damaged, the damage may be visually recognized by a user.

As described above, when air bubbles enter between the inorganic layer and the protection member or when the protection member corresponding to the input area is damaged, it is necessary to replace the protection member on the inorganic layer with a new protection member. However, when peeling the protection member off from the inorganic layer, if adhesion strength between the protection member and the inorganic layer is relatively high, a part of the protection member may remain on the inorganic layer. If a part of the protection member remains on the inorganic layer, dust in the atmosphere may be attached to the part of the protection member remaining on the inorganic layer, and viewability of the input device may be degraded.

Therefore, in the embodiment, the protection member 12 includes the organic layer 12a having adhesiveness and the protection layer 12b. In addition, the organic layer 12a contacts with the inorganic layer 11, and the protection layer 12b is provided on the organic layer 12a. Herein, the adhesion strength between the inorganic material and the organic material is relatively low. Accordingly, it is possible to easily peel the protection member 12 off from the inorganic layer 11, and it is possible to reduce a possibility of a part of the organic layer 12a remaining on the inorganic layer 11. That is, it is possible to easily perform replacing of the protection member 12.

In the embodiment, the protection member 12 is only provided on the inorganic layer 11 corresponding to the input area E1. Accordingly, the organic layer 12a does not contact with a member other than the inorganic layer 11, and the protection member 12 is more easily peeled off. The protection member 12 may be provided on the second insulating layer 10 corresponding to the non-input area E2.

In the embodiment, as described above, the insulator 5 is provided in the intersected portion C1. Herein, since the insulator 5 is formed of an organic material, adhesion strength between the insulator 5 and the organic layer 12a is relatively high. Accordingly, in a case where the insulator 5 contacts with the organic layer 12a, when the protection member 12 is peeled off, a part of the organic layer 12a may remain on the insulator 5. Therefore, in the embodiment, the inorganic layer 11 is positioned on the insulator 5. In detail, the inorganic layer 11 coats the insulator 5. Herein, as illustrated in FIG. 3 and FIG. 4, a portion where the second interelectrode wire 4b is positioned and a portion where the second interelectrode wire 4b is not positioned exist on the end surface 5a of the insulator 5. A surface of the portion on the end surface 5a of the insulator 5 where the second interelectrode wire 4b is not positioned is exposed from the second interelectrode wire 4b. The surface of the portion on the end surface 5a of the insulator 5 where the second interelectrode wire 4b is not positioned is referred to as an exposed surface 5aa. Herein, the inorganic layer 11 contacts with the exposed surface 5aa. Therefore, the insulator 5 does not contact with the organic layer 12a, and when the protection member 12 is peeled off, it is possible to reduce a possibility of a part of the organic layer 12a remaining on the insulator 5.

Further, in the embodiment, a thickness of the organic layer 12a is larger than the thickness of the inorganic layer 11. Therefore, even when the thickness of the inorganic layer 11 is relatively small, it is possible to efficiently protect the first detection electrode pattern 3, the second detection electrode pattern 4, and the insulator 5.

The protection sheet 13 protects the first main surface 2a of the base 2 from being damaged by contact with the finger F1 of a user. The protection sheet 13 is provided on the adhesion layer 14 over the entire surface of the first main surface 2a of the base 2. The protection sheet 13 may only be provided on the first main surface 2a of the base 2 corresponding to the input area E1. As a material constituting the protection sheet 13, the same material as that of the protection layer 12b is used. As a material constituting the adhesion layer 14, the same material as that of the organic layer 12a is used.

Next, a detection principle of the input device X1 will be described.

A position detection driver (not shown) is electrically connected to the detection wires 8 positioned in the external conductive area G1. A power device (not shown) is electrically connected to the detection wires 8 positioned in the external conductive area G1. The power device supplies a voltage to the first detection electrode pattern 3 and the second detection electrode pattern 4. Herein, when the finger F1 as a conductor approaches, contacts with, or presses the first main surface 2a of the base 2 corresponding to the input area E1 through the protection sheet 13, the capacitance is generated between the finger F1, and the first detection electrode 3a and the second detection electrode 4a. The position detection driver constantly detects the capacitance generated in the first detection electrode pattern 3 and the second detection electrode pattern 4, and detects the input position where a user performed the input operation, using a combination of the first detection electrode pattern 3 and the second detection electrode pattern 4 where capacitance equal to or more than a predetermined value is detected. By doing so, the input device X1 can detect the input position.

As described above, in the input device X1, it is possible to reduce a possibility of damage to the first detection electrode pattern 3 and the second detection electrode pattern 4 due to contact with the outside, and to reduce a possibility of corrosion of the first detection electrode pattern 3 and the second detection electrode pattern 4.

Next, the display device Y1 including the input device X1 will be described with reference to FIG. 6.

As illustrated in FIG. 6, the display device Y1 according to the embodiment includes the input device X1, the first housing 100, a display panel 200, a backlight 300, and a circuit board 400.

The input device X1 is supported by the first housing 100. In detail, the input device X1 is provided on a support member P1 on a support 101 of the first housing 100. The support member P1 may not be provided, and the input device X1 may be directly provided on the support 101 of the first housing 100. As a material constituting the first housing 100, a resin such as polycarbonate or metal such as stainless steel or aluminum is used, for example.

The display panel 200 displays an image. The display panel 200 includes an upper substrate 201, a lower substrate 202, a liquid crystal layer 203, and a sealing member 204.

The upper substrate 201 is disposed to oppose the second main surface 2b of the base 2 of the input device X1. The input device X1 may be provided on the upper substrate 201 via a fixing member. As the fixing member, double-sided tape, a thermosetting resin, an ultraviolet curable resin, or a stopper such as a screw is used, for example. In particular, an optical adhesion member is preferably used, in order to improve viewability. The lower substrate 202 is disposed to oppose the upper substrate 201. As a material constituting the upper substrate 201 and the lower substrate 202, glass or a transparent resin material such as plastic is used, for example.

The liquid crystal layer 203 is a display member layer for displaying an image, and is interposed between the upper substrate 201 and the lower substrate 202. In detail, the liquid crystal layer 203 is sealed in an area between the upper substrate 201 and the lower substrate 202, by using the upper substrate 201, the lower substrate 202, and the sealing member 204. In the display panel 200 according to the embodiment, the liquid crystal layer 203 is included as a display member layer, but the structure is not limited thereto. A plasma generation layer, an organic EL layer, or the like may be included, instead of the liquid crystal layer 203.

The backlight 300 emits light over the entire lower surface of the display panel 200. The backlight 300 is disposed in the rear of the display panel 200. The backlight 300 includes a light source 301 and a light guide plate 302. The light source 301 is a member which emits light towards the light guide plate 302 and is configured with a light emitting diode (LED). The light source 301 may not be configured with the LED, and may be configured with a cold cathode fluorescent lamp, a halogen lamp, a xenon lamp, or an electro-luminescence (EL) lamp, for example. The light guide plate 302 is a member for guiding the light from the light source 301 substantially uniquely over the entire lower surface of the display panel 200. In a case of using a display panel using a self-luminous element, instead of the display panel 200, the backlight 300 may not be provided.

The circuit board 400 supports an electronic component such as a control circuit which controls the display panel 200 and the backlight 300, a resistor, or a capacitor. The circuit board 400 is disposed in the rear of the backlight 300. The control circuit on the circuit board 400 is electrically connected to the display panel 200 and the backlight 300, by a flexible printed wiring board (not shown) or the like. The circuit board 400 may include the position detection driver of the input device X1. In addition, the plurality of circuit boards 400 may be provided. As a material constituting the circuit board 400, a resin material is used, for example.

As described above, since the display device Y1 allows the input operation of the input area E1 of the input device X1 while allowing the display panel 200 to be seen through the input device X1, it is possible to input various pieces of information. In addition, a function of presenting various senses of touch such as pressing, tracing, or feeling, when inputting various pieces of information, to a user who inputs the information may be applied to the input device X1. In this case, it is possible to realize the function described above by providing one or a plurality of vibrating bodies (for example, piezoelectric elements, or the like) on the base 2 of the input device X1, and when a predetermined input operation or a predetermined pressing load is detected, vibrating the vibrating bodies at a predetermined frequency.

As described above, since the display device Y1 includes the input device X1, it is possible to reduce a possibility of damage to the first detection electrode pattern 3 and the second detection electrode pattern 4 due to contact with the outside, and to reduce a possibility of corrosion of the first detection electrode pattern 3 and the second detection electrode pattern 4.

Next, a mobile terminal Z1 including the display device Y1 will be described with reference to FIG. 7.

As illustrated in FIG. 7, the mobile terminal Z1 according to the embodiment is a smart phone terminal. The mobile terminal Z1 is not limited to the smart phone terminal, and may be electronic equipment such as a mobile phone, a tablet terminal, or a personal digital assistant (PDA), for example. The mobile terminal Z1 includes the display device Y1, a voice input unit 501, a voice output unit 502, a key input unit 503, and a second housing 504.

The voice input unit 501 inputs a voice of a user, and is configured with a microphone or the like. The voice output unit 502 outputs a voice or the like of a person on the other end of the line, and is configured with an electromagnetic speaker or a piezoelectric speaker. The key input unit 503 is configured with mechanical keys. The key input unit 503 may be operation keys displayed on a display screen. The second housing 504 accommodates the display device Y1, the voice input unit 501, the voice output unit 502, and the key input unit 503. The second housing 504 may not be provided, and the voice input unit 501, the voice output unit 502, and the key input unit 503 may be accommodated in the first housing 100 of the display device Y1. As a material constituting the second housing 504, the same material as that of the first housing 100 of the display device Y1 is used.

In addition, the mobile terminal Z1 may include a digital camera functional unit, a one-segment broadcasting tuner, a near field communication unit such as an infrared communication functional unit, a wireless LAN module, a Bluetooth (trade mark) module, and various interfaces, depending on a necessary function, but specific drawings and descriptions thereof will be omitted.

As described above, since the mobile terminal Z1 includes the display device Y1, it is possible to reduce a possibility of damage to the first detection electrode pattern 3 and the second detection electrode pattern 4 due to contact with the outside, and to reduce a possibility of corrosion of the first detection electrode pattern 3 and the second detection electrode pattern 4.

Herein, the display device Y1 may be included in various electronic equipment such as a programmable display used in industrial fields, an electronic notebook, a personal computer, a copier, a portable game device, a television, and a digital camera, instead of being included in the mobile terminal Z1 described above.

The embodiment above describes a specific example of the embodiment of the present invention, and various modifications can be made. Hereinafter, some main modification examples will be described.

### MODIFICATION EXAMPLE 1

FIG. 8 is a plan view illustrating a schematic configuration of an input device X2 according to Modification Example 1. FIG. 9 is a plan view illustrating a schematic configuration of the input device X2 according to Modification Example 1 and is a view seen through the base 2. FIG. 10 is a cross-sectional view taken along line IV-IV shown in FIG. 9. FIG. 11 is a cross-sectional view taken along line V-V shown in FIG. 9. FIG. 12 is a cross-sectional view taken along line VI-VI shown in FIG. 9. In FIGS. 8 to 12, the same reference numerals denote elements having the same functions as in FIGS. 1 to 4, and the specific descriptions thereof will be omitted. For convenience of description, the insulator 5, the protection sheet 13, and the adhesion layer 14 are omitted in FIG. 8.

As illustrated in FIGS. 8 to 12, the input device X2 includes an inorganic layer 15, instead of the inorganic layer 11 included in the input device X1. The inorganic layer 15 is provided on the second main surface 2b of the base 2 corresponding to the input area E1. The inorganic layer 15 coats the first detection electrode pattern 3 and the second detection electrode pattern 4 in plan view. A thickness S1 of the inorganic layer 15 positioned in a corner A1 formed by the second main surface 2b of the base 2 and the end surface 5a of the insulator 5 is larger than a thickness S2 of the inorganic layer 15 positioned on the first detection electrode pattern 3 and the second detection electrode pattern 4. Herein, the thickness of the inorganic layer 15 positioned in the corner A1 indicates a shortest distance from the corner A1 to the surface of the inorganic layer 15. In addition, the thickness of the inorganic layer 15 positioned on the first detection electrode pattern 3 and the second detection electrode pattern 4 indicates a shortest distance from the surface of the first detection electrode pattern 3 and the second detection electrode pattern 4 to the inorganic layer 15. As described above, since the thickness S1 is larger than the thickness S2 regarding the inorganic layer 15, it is possible to reduce differences between concavities and convexities generated on the inorganic layer 15. Therefore, in the input device X2, it is possible to reduce a possibility of air bubbles entering between the inorganic layer 15 and the organic layer 12a, as compared to the input device X1.

A thickness of the inorganic layer 15 on the first detection electrode 3a may be larger than the total thickness of the insulator 5 and the second interelectrode wire 4b. In this case, it is possible to form the surface of the inorganic layer 15 to be substantially planarized, and it is possible to further reduce a possibility of air bubbles entering between the inorganic layer 15 and the organic layer 12a.

### MODIFICATION EXAMPLE 2

FIG. 13 is a plan view illustrating a schematic configuration of an input device X3 according to Modification Example 2. FIG. 14 is a plan view illustrating a schematic configuration of the input device X3 according to Modification Example 2 and is a view seen through the base 2. FIG. 15 is a cross-sectional view taken along line VII-VII shown in FIG. 14. In FIGS. 13 to 15, the same reference numerals denote elements having the same functions as in FIGS. 1, 2, and 5, and the specific descriptions thereof will be omitted. For convenience of description, the insulator 5, the protection sheet 13, and the adhesion layer 14 are omitted in FIG. 13.

As illustrated in FIGS. 13 to 15, the input device X3 includes an inorganic layer 16, instead of the inorganic layer 11 included in the input device X1. The inorganic layer 16 is provided on the second main surface 2b of the base 2 corresponding to the input area E1. The inorganic layer 16 coats the first detection electrode pattern 3 and the second detection electrode pattern 4 in plan view. In addition, the inorganic layer 16 extends on the second insulating layer 10 corresponding to the non-input area E2. Herein, when forming the second insulating layer 10 on the second main surface 2b of the base 2, the base 2 may be bent due to a difference in internal stress between the base 2 and the second insulating layer 10. Therefore, in Modification Example 2, the second insulating layer 10 is interposed between the base 2 and the inorganic layer 16. Accordingly, in a case where the base 2 is glass formed of an inorganic material, for example, since a difference in internal stress between the base 2 and the inorganic layer 16 is small, the bending of the base 2 due to a difference in internal stress between the base 2 and the second insulating layer 10 is alleviated. Therefore, in the input device X3, it is possible to reduce a possibility of bending of the base 2, compared to the input device X1.

In Modification Example 2, as illustrated in FIG. 14, the inorganic layer 16 is not positioned in the external conductive area G1 on the second main surface 2b of the base 2. Therefore, the detection wires 8 can be exposed to the external conductive area G1, and the detection wires 8 can be electrically connected to a flexible printed wiring board (not shown).

### MODIFICATION EXAMPLE 3

FIG. 16 is a plan view illustrating a schematic configuration of an input device X4 according to Modification Example 3. FIG. 17 is a plan view illustrating a schematic configuration of the input device X4 according to Modification Example 3 and is a view seen through the base 2. FIG. 18 is a cross-sectional view taken along line VIII-VIII shown in FIG. 17. In FIGS. 16 to 18, the same reference numerals denote elements having the same functions as in FIGS. 1, 2, and 5, and the specific descriptions thereof will be omitted. For convenience of description, the insulator 5, the protection sheet 13, and the adhesion layer 14 are omitted in FIG. 16.

As illustrated in FIGS. 16 to 18, the input device X4 includes an inorganic layer 17, instead of the inorganic layer 11 included in the input device X1. The inorganic layer 17 is positioned on the second main surface 2b of the base 2 corresponding to the input area E1. The inorganic layer 17 coats the first detection electrode pattern 3 and the second detection electrode pattern 4 in plan view. In addition, the inorganic layer 17 extends on the second insulating layer 10 corresponding to the non-input area E2. Further, the inorganic layer 17 coats the second insulating layer 10. Herein, the inorganic material has a property of not allowing penetration of moisture. Therefore, in the input device X4, it is possible to reduce a possibility of corrosion of the detection wires 8 due to absorption of moisture through the second insulating layer 10, compared to the input device X1. In addition, in Modification Example 3, the inorganic layer 17 coats the first insulating layer 7. Therefore, it is possible to reduce a possibility of corrosion of the light shielding layer 6 due to absorption of moisture through the first insulating layer 7.

Further, in Modification Example 3, the inorganic layer 17 is provided to be separated from the end surface 2c of the base 2 by a predetermined distance L1 or longer. Herein, the predetermined distance L1 means a distance between the end surface 2c of the base 2 and the end portion 17a of the inorganic layer 17 in a cross-sectional view. Accordingly, in manufacturing the input device X4, for example, when performing polishing of the end surface 2c of the base 2 with a predetermined tool, it is possible to reduce a possibility of contact of the tool with the inorganic layer 17. Therefore, it is possible to reduce a possibility of peeling of the inorganic layer 17 from the second main surface 2b of the base 2.

The predetermined distance L1 is preferably 0.1 mm to 0.5 mm. If L1 is smaller than 0.1 mm, it is difficult to sufficiently reduce a possibility of contact of the inorganic layer 17 with any member. In addition, if L1 is larger than 0.5 mm, a distance between the light shielding layer 6 and the end surface 2c of the base 2 increases to a degree to be visually recognized by a user, and thus appearance of the input device X4 is degraded. Therefore, the predetermined distance L1 is preferably 0.1 mm to 0.5 mm.

### MODIFICATION EXAMPLE 4

FIG. 19 is a cross-sectional view illustrating a display device Y2 according to Modification Example 4. FIG. 20 is an enlarged view of an area H1 surrounded with a dashed-dotted line illustrated in FIG. 19. In FIGS. 19 and 20, the same reference numerals denote elements having the same functions as in FIGS. 5 and 6, and the specific descriptions thereof will be omitted.

As illustrated in FIG. 19 and FIG. 20, the display device Y2 includes an input device X5, a first housing 600, and a display panel 700, instead of the input device X1, the first housing 100, and the display panel 200 included in the display device Y1.

The first housing 600 accommodates the display panel 700, the backlight 300, and the circuit board 400. The first housing 600 includes a support 601.

The display panel 700 displays an image. The display panel 700 includes an upper substrate 701, a lower substrate 702, a liquid crystal layer 703, and a sealing member 704. The upper substrate 701 is disposed to oppose the input device X5. The lower substrate 702 is disposed to oppose the upper substrate 701, under the upper substrate 701. The liquid crystal layer 703 is positioned in an area surrounded by the upper substrate 701, the lower substrate 702, and the sealing member 704. The lower substrate 702 of the display panel 700 is supported on the support 601 of the first housing 600.

The input device X5 is positioned on the display panel 700. The input device X5 includes an inorganic layer 18 and a protection member 19, instead of the inorganic layer 11 and the protection member 12 included in the input device X1.

The inorganic layer 18 is positioned on the second main surface 2b of the base 2 corresponding to the input area E1. The inorganic layer 18 coats the first detection electrode pattern 3 and the second detection electrode pattern 4 in plan view. In addition, the inorganic layer 18 coats the second insulating layer 10 corresponding to the non-input area E2.

The protection member 19 includes an organic layer 19a and a protection layer 19b. The organic layer 19a has adhesiveness. The organic layer 19a is positioned on the inorganic layer 18 corresponding to the input area E1 and the non-input area E2. As a material constituting the organic layer 19a, an optical adhesion member such as an ultraviolet curable resin is used, for example. The protection layer 19b is provided on the organic layer 19a. Herein, in the display device Y2, the protection layer 19b and the upper substrate 701 are configured with the same member. Therefore, in the display device Y2, it is possible to have a relatively small thickness.

### MODIFICATION EXAMPLE 5

In the present specification, the embodiments and Modification Examples 1 to 4 have been individually described in detail, but not limited thereto, and an example obtained by appropriately combining configurations individually described in the embodiments and Modification Examples 1 to 4 is also described. That is, the input device according to the present invention is not limited to the input devices X1 to X5, and also includes an input device having appropriately combined configurations described in the embodiments and Modification Examples 1 to 4.

In the embodiment, the display device Y1 including the input device X1 has been described, but not limited thereto, and the input devices X2 to X5 may be used, instead of the input device X1.

In the embodiment, the mobile terminal Z1 including the input device X1 has been described, but not limited thereto, and the input devices X2 to X5 may be used, instead of the input device X1.

### REFERENCE SIGNS LIST

X1 to X5 INPUT DEVICE

Y1 to Y2 DISPLAY DEVICE

Z1 MOBILE TERMINAL

A1 CORNER

C1 INTERSECTED PORTION

2 BASE

2b SECOND MAIN SURFACE OF BASE

2c END SURFACE OF BASE 2

3 FIRST DETECTION ELECTRODE PATTERN

3a FIRST DETECTION ELECTRODE

3b FIRST INTERELECTRODE WIRE

4 SECOND DETECTION ELECTRODE PATTERN

4a SECOND DETECTION ELECTRODE

4b SECOND INTERELECTRODE WIRE

5 INSULATOR

5aa EXPOSED SURFACE

8 DETECTION WIRE

10 SECOND INSULATING LAYER

11, 15, 16, 17, 18 INORGANIC LAYER

12, 19 PROTECTION MEMBER

12a, 19a ORGANIC LAYER

12b, 19b (701) PROTECTION LAYER

100, 600 FIRST HOUSING

200, 700 DISPLAY PANEL

701 (19b) UPPER SUBSTRATE

1. An input device comprising:
a base;
a detection electrode pattern on a main surface of the base;
an inorganic layer on the main surface of the base so as to cover the detection electrode pattern in plan view; and
a protection member on the inorganic layer,
wherein the protection member includes an organic layer which contacts with the inorganic layer and has adhesiveness, and a protection layer on the organic layer.

2. The input device according to claim 1, wherein
the detection electrode pattern includes a first detection electrode pattern and a second detection electrode pattern,
the input device further includes an insulator that is provided in an intersected portion where the first detection electrode pattern and the second detection electrode pattern intersect with each other, and that electrically insulates the first detection electrode pattern and the second detection electrode pattern from each other,
the insulator is formed of an organic material, and
the inorganic layer is positioned on the insulator.

3. The input device according to claim 2, wherein
a part of the second detection electrode pattern is positioned on the insulator,
the insulator includes an exposed surface which is exposed from the part of the second detection electrode pattern, and
the inorganic layer contacts with the exposed surface.

4. The input device according to claim 2,
wherein a thickness of the inorganic layer positioned in a corner formed by the main surface of the base and the insulator is larger than a thickness of the inorganic layer positioned on the detection electrode pattern.

5. The input device according to claim 1, further comprising:
detection wires on the main surface of the base and electrically connected to the detection electrode pattern; and
an insulating layer on the main surface of the base and positioned on the detection wires, wherein
the inorganic layer extends on the insulating layer, and
the insulating layer is interposed between the base and the inorganic layer.

6. The input device according to claim 5,
wherein the inorganic layer is provided to be separated from an end surface of the base by a predetermined distance or longer.

7. The input device according to claim 1,
wherein a thickness of the organic layer is larger than the thickness of the inorganic layer.

8. A display device comprising:
the input device according to claim 1;
a display panel which is disposed to oppose the input device; and
a housing which accommodates the display panel.

9. Electronic equipment comprising the display device according to claim 8.

10. The input device according to claim 3,
wherein a thickness of the inorganic layer positioned in a corner formed by the main surface of the base and the insulator is larger than a thickness of the inorganic layer positioned on the detection electrode pattern.

11. The input device according to claim 2, further comprising:
detection wires on the main surface of the base and electrically connected to the detection electrode pattern; and
an insulating layer on the main surface of the base and positioned on the detection wires, wherein
the inorganic layer extends on the insulating layer, and
the insulating layer is interposed between the base and the inorganic layer.

12. The input device according to claim 11,
wherein the inorganic layer is provided to be separated from an end surface of the base by a predetermined distance or longer.

13. The input device according to claim 3, further comprising:
detection wires on the main surface of the base and electrically connected to the detection electrode pattern; and
an insulating layer on the main surface of the base and positioned on the detection wires, wherein
the inorganic layer extends on the insulating layer, and
the insulating layer is interposed between the base and the inorganic layer.

14. The input device according to claim 13,
wherein the inorganic layer is provided to be separated from an end surface of the base by a predetermined distance or longer.

15. The input device according to claim 4, further comprising:
detection wires on the main surface of the base and electrically connected to the detection electrode pattern; and
an insulating layer on the main surface of the base and positioned on the detection wires, wherein
the inorganic layer extends on the insulating layer, and
the insulating layer is interposed between the base and the inorganic layer.

16. The input device according to claim 15,
wherein the inorganic layer is provided to be separated from an end surface of the base by a predetermined distance or longer.
